(19) United States
(12) Patent Application Publication
(10) Pub. No.: US 2005/0153180 A1
(43) Pub. Date: Jul. 14, 2005

(54) Functional test and demonstration apparatus for fuel cell power system

(76) Inventor: Yao-Sheng Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/028,055

(22) Filed: Jan. 4, 2005

(30) Foreign Application Priority Data
Jan. 9, 2004 (TW) 93100567

(51) Int. Cl. H01M 8/04

(52) U.S. Cl. 429/22; 429/23; 429/24; 429/25; 429/26

(57) ABSTRACT

A functional test and demonstration apparatus is provided for a fuel cell power system, which includes a mainframe for supporting a fuel cell stack. A hydrogen supply module supplies hydrogen to the fuel cell stack, and excessive hydrogen flows out from a hydrogen gas outlet of the fuel cell stack. Air is drawn in and supplied to the fuel cell stack by a blowing device, and flows out from an air outlet of the fuel cell stack. A liquid cooling device is connected between a coolant inlet and a coolant outlet of the fuel cell stack to remove heat from the fuel cell stack. A humidifier is used to properly humidify the air before it is conveyed to the fuel cell stack. The signals detected from various components of the fuel cell power system are sent to a control device which controls the operation of the components.

### FIELD OF THE INVENTION

The present invention relates generally to a fuel cell power system, and in particular to a functional test and demonstration apparatus for a fuel cell power system with liquid cooling device.

### BACKGROUND OF THE INVENTION

A fuel cell is a power-generating unit that generates electrical energy through electrochemical reaction of hydrogen and oxygen. The fuel cell has the advantages of high energy conversion efficiency, clean exhaust, low noise, and environmentally friendly, as compared with a conventional internal combustion engine. In the past few years, it has been highly promoted and developed worldwide.

Fuel cell is classified based on the electrolyte thereof. Among these known fuel cells, the proton exchange membrane fuel cell (PEMFC) is the most-developed technique, having the advantages of low operation temperature, fast start-up and high power density. As a whole, PEMFC has high value for industry.

In the course of research and development or maintenance, in order to perform inspection of functionality and performance upon a fuel cell stack, the fuel cell stack has to be connected physically and electrically with other components for form a fuel cell power system. Moreover, in promotion of new product, exhibition and training of workers, either demonstrators or sellers have to repeatedly set up the pipelines and electrical connections among the various components of the fuel cell power system in order to illustrate the operation principle and demonstrate the functions of the fuel cell power system to clients or trainees.

However, there is no appropriate apparatus in the market that can facilitate the functional tests or demonstration of a fuel cell power system. It is not easy for the clients to know well the features of the fuel cell power system. Moreover, to perform inspection of functionality and performance in the course of research and development and maintenance, researchers and technicians often spend a lot of time in setting up and testing the pipelines and electrical connections among various components of the fuel cell power system.

Because a fuel cell power system includes many components, when one or more of these components does not work properly, the fuel cell power system cannot operate properly. Anyway, it is not easy and takes lot of time for the researchers and technicians to find out the cause(s). All these drawbacks are unfavorable to the promotion and application of fuel cell.

It is thus desired to provide a functional test and demonstration apparatus for a fuel cell power system, which is easy to operate and simple to set up.

### SUMMARY OF THE INVENTION

An object of the present invention is to provide a functional and demonstration apparatus for a fuel cell power system. It is easy to set up the piping system and electrical connections, and therefore it facilitates the inspection of functionality and performance to the fuel cell power system.

Another object of the present invention is to provide a functional and demonstration apparatus for a fuel cell power system. With the apparatus, the operation principle, electrical characteristics and gas supplies of the fuel cell power system are clearly displayed. Accordingly, the user can know well about the configuration and performance of the fuel cell power system.

A further object of the present invention is to provide a functional test and demonstration apparatus for a fuel cell power system comprising a liquid cooling device. Liquid cooling device can efficiently remove heat from the fuel cell power system and maintain the fuel cell power system at appropriate temperature range.

To achieve the above objects, in accordance with the present invention, there is provided a functional test and demonstration apparatus for a fuel cell power system. The functional test and demonstration apparatus comprises a mainframe for supporting a fuel cell stack. A hydrogen supply module and an air blowing device are provided for the anode and cathode of fuel cell stack individually and flow rate can be controlled according to the power demand. A liquid cooling device is connected to the fuel cell stack for removing heat from the fuel cell stack. A humidifier is used to properly humidify the air before it is flowed into the fuel cell stack. A DC electronic load is used to measure the performance of the fuel cell stack. The signals detected from various components of the fuel cell power system are sent to a control device which controls the operation of the components.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a functional test and demonstration apparatus constructed for a fuel cell power system in accordance with a preferred embodiment of the present invention;

FIG. 2 is a system block diagram of the fuel cell power system of the present invention; and

FIG. 3 is a front plane view showing a connection and display panel of the functional test and demonstration apparatus of FIG. 1.

### DETAILED DESCRIPTION OF THE PREFERRED EMBODIMENTS

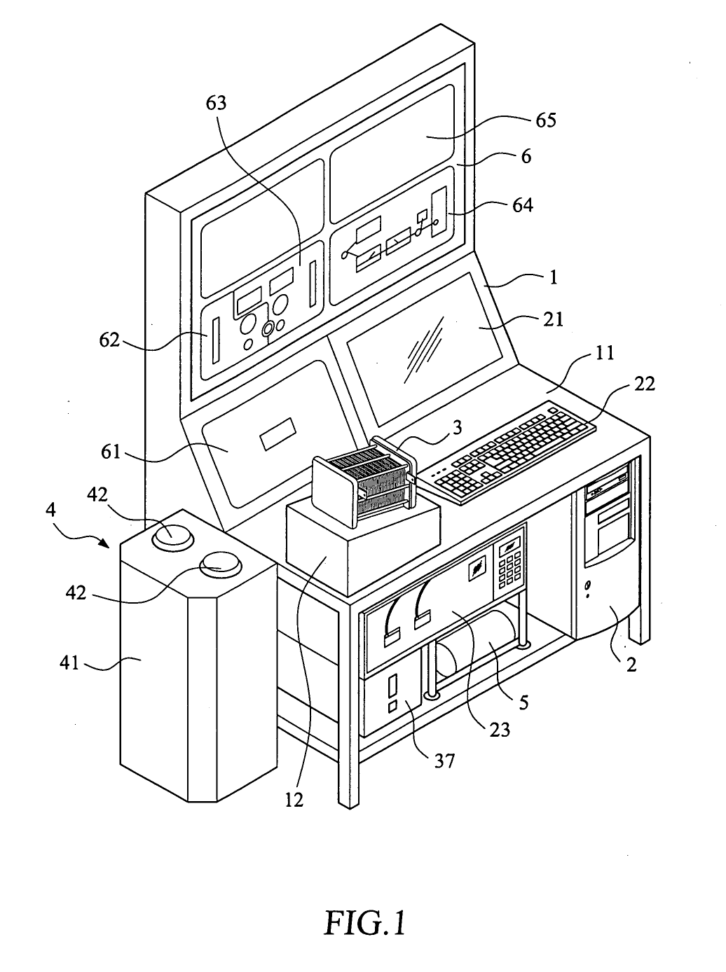

With reference to the drawings and in particular to FIG. 1, a functional test and demonstration apparatus for a fuel cell power system in accordance with the present invention is shown. The functional test and demonstration apparatus comprises a mainframe 1 for supporting a control device 2. The control device 2 is coupled with a display 21 and an input device 22 such as a keyboard. The display 21 shows the performance and data, including signals, parameters, charts and so on, of the fuel cell power system.

A stand 12, which has an inclined top surface, is provided on a plane surface of the mainframe 1 for supporting a fuel cell stack 3. The fuel cell stack 3 is placed in a manner, such that one end of the fuel cell stack 3, where a hydrogen gas outlet 32 and an air outlet 34 are arranged, is positioned at a vertically lower position. This allows the water produced in electrochemical reaction to be drained smoothly out from the fuel cell stack 3.

Also, a DC electronic load 23 is disposed on the mainframe 1, which acts as a load simulator for the fuel cell stack 3.

A liquid cooling device 37 is arranged at an appropriate position on the mainframe 1, for removing heat from the fuel cell stack 3.

Hydrogen is supplied to the fuel cell stack 3 by a hydrogen supply module 4. The hydrogen supply module 4 comprises at least one chamber 41 with a heat exchanger 411 and a plurality of low pressure hydrogen storage canisters 42 accommodated therein. The hydrogen supply module 4 is arranged at one side of the mainframe 1 and connected to the fuel cell stack 3 by means of tubes for supplying hydrogen to the fuel cell stack 3 for performing electrochemical reaction therein. The hydrogen supply module 4 may comprise other hydrogen supply device to provide hydrogen to the fuel cell stack 3.

Moreover, the fuel cell power system includes a blowing device 5 for drawing in and supplying air to the fuel cell stack 3 for proceeding electrochemical reaction. Air is conveyed to the fuel cell stack 3 by an air supply pipeline.

The mainframe 1 comprises a connection and display panel 6 for connection of pipelines and wires and display of various data and performance of the fuel cell stack 3, including hydrogen gas supply, air supply, humidity of inlet air, monitored parameters like voltage, current, temperature and so on. The detailed functions of the connection and display panel 6 will be discussed later.

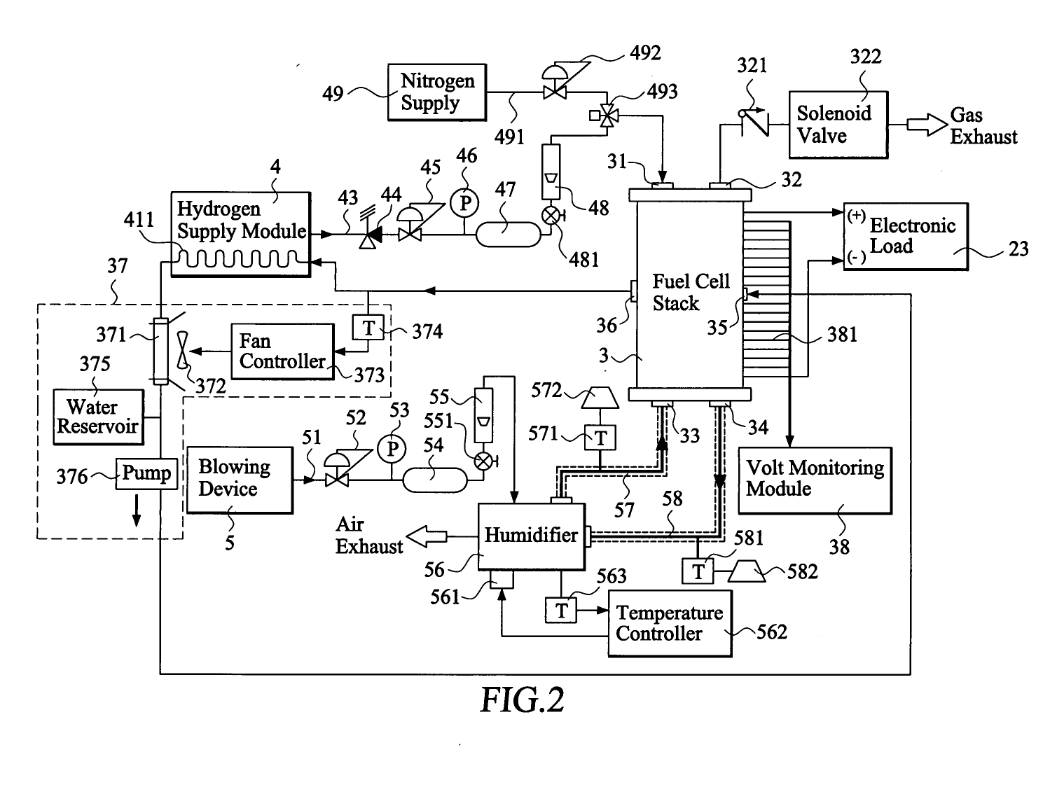

FIG. 2 is a system block diagram showing connections among the various components of the fuel cell power system. The fuel cell stack 3 comprises a plurality of membrane electrode assemblies (MEA). Each of the membrane electrode assemblies includes an anode catalyst layer, a proton exchange membrane and a cathode catalyst layer, forming a basic unit for performing electrochemical reaction. The membrane electrode assembly is stacked and combined with a hydrogen gas diffusion layer and a bipolar plate to form a cell unit. Further, a liquid flow field is arranged between the hydrogen bipolar plate and air bipolar plate to remove heat therefrom and maintain the fuel cell stack at a proper operation temperature range. The cell units are stacked, and then mounted with current collectors and endplates at the two ends thereof to form a fuel cell stack. The membrane electrode assemblies are electrically connected in series to generate a D.C. power with predetermined voltage value and current value. The power is supplied to the electronic load 23 via a positive terminal (+) and a negative terminal (−).

To perform electrochemical reaction, the fuel cell stack 3 requires a continuous and sufficient supply of hydrogen and air. Hydrogen is conveyed from the hydrogen supply module 4 via a hydrogen supply pipeline 43 to a hydrogen gas inlet 31 of the fuel cell stack 3. The hydrogen supply pipeline 43 comprises an emergency button 44, a pressure regulating valve 45 and a pressure gauge 46. The emergency button 44 is used for terminating the hydrogen supply to the fuel cell stack 3 and power supply from the fuel cell stack 3 at emergency. The pressure regulating valve 45 includes a pressure reducing valve, and is used to regulate and reduce the hydrogen pressure. The pressure gauge 46 measures and indicates the hydrogen pressure in the hydrogen supply pipeline 43.

Moreover, a mass flow controller 47 and a gas flow rotameter 48 are arranged at the hydrogen supply pipeline 43. The mass flow controller 47 is a precise integrated device enable to provide flow metering and flow control, which is used to measure the mass flow rate of hydrogen. The gas flow rotameter 48 is provided with a see-through window, through which the researcher or user can monitor the hydrogen flow. Besides, a hydrogen flow control knob 481 is arranged preceding the gas flow rotameter 48, which is used for cross verification of the mass flow controller 47 and a gas flow rotameter 48.

The hydrogen supply pipeline 43 is connected with a nitrogen supply pipeline 491 and a hydrogen gas inlet 31 of the fuel cell stack 3 by a three-way valve 493. Nitrogen is supplied from a nitrogen supply 49 through the nitrogen supply pipeline 491. A pressure regulating valve 492 is disposed at the nitrogen supply pipeline 491 for regulating the nitrogen pressure. To enhance the performance and maintain the stability of the fuel cell stack 3, nitrogen is supplied to the fuel cell stack 3 through the three-way valve 493 for purging the impure gases or residual hydrogen gas in the hydrogen supply pipeline 43 before and after the operation of the fuel cell stack 3.

Hydrogen flows through the hydrogen gas inlet 31 and reacts with oxygen to perform electrochemical reaction in the fuel cell stack 3. Excessive hydrogen is conveyed to flow out from the hydrogen gas outlet 32 of the fuel cell stack 3. The hydrogen gas outlet 32 is connected with a check valve 321 and a solenoid valve 322. The check valve 321 allows hydrogen gas to flow in one direction only, namely, from the hydrogen gas outlet 32 to a gas exhaust. Moreover, the solenoid valve 322 can be driven to open or close, for the purpose of draining the water accumulated in the fuel cell stack.

Hydrogen can be supplied either by close loop or by open loop system, depending on requirements. When using open loop system, the hydrogen flow rate may be fixed or varied. The hydrogen flow rate can be varied by changing the Stoichiometric ratio of hydrogen to oxygen, depending on the fuel cell output voltage and current. When using close loop system, the hydrogen consumption rate is measured and compared with the theoretical value and output power of the fuel cell stack. Accordingly, the performance of the fuel cell stack 3 is known.

For the reaction air, the blowing device 5, which may comprise an oil less air compressor, draws in air and supplies air to an air inlet 33 of the fuel cell stack 3 through the air supply pipeline 51. The air supply pipeline 51 comprises a pressure regulating valve 52 for regulating the air pressure, a pressure gauge 53 for measuring the air pressure, and a mass flow controller 54 for metering and controlling air mass flow rate. Also, the air supply pipeline is provided with a gas flow rotameter 55 which enables the researcher or user to view the air flow. An air flow control knob 551 is arranged preceding the gas flow rotameter 55, which is used for cross verification of the mass flow controller 54 and gas flow rotameter 55.

Air is supplied by open loop system. The air flow rate may be fixed or varied. The air flow rate is varied by changing the Stoichiometric ratio of hydrogen to oxygen, depending on the fuel cell output voltage and current. Accordingly, the influence of air flow rate to the performance of the fuel cell stack 3 can be studied.

The air supply pipeline 51 further comprises a humidifier 56. The reaction air is humidified by the humidifier 56 before flowing into the fuel cell stack 3, so that the reaction air contains an appropriate amount of moisture which is important for the normal operation of the fuel cell stack 3. The conduit connecting the humidifier 56 and the air inlet 33 of the fuel cell stack 3 is heat-insulated by a thermal sleeve 57. In this way, the air humidity is maintained. The air supply pipeline 51 is provided with a temperature sensor 571 for detecting the inlet air temperature and a temperature meter 572 for indicating the inlet air temperature.

Air is conveyed to the fuel cell stack 3 via the air inlet 33 to perform electrochemical reaction therein. Excessive air flows out from the air outlet 34 of the fuel cell stack 3, via the humidifier 56 to an air exhaust. The conduit connecting between the fuel cell stack 3 and the humidifier 56 is heat-insulated by a thermal sleeve 58. The air supply pipeline is also provided with a temperature sensor 581 for detecting the outlet air temperature and a temperature meter 582 for indicating the outlet air temperature. The efficiency of the humidifier 56 can be known from the temperatures of the inlet air and the outlet air by reading the inlet air temperature meter 572 and outlet air temperature meter 582.

Besides, the humidifier 56 is equipped with a heater 561 such as a heating pad and a temperature controller 562. By means of the temperature controller 562, the temperature of the humidifier 56 is controlled, and in turn, humidification of the humidifier 56 to inlet air is regulated to some extent. Accordingly, the effect of the air humidity to the performance of the fuel cell stack 3 can be examined. The temperature of the humidifier 56 is detected by a temperature sensor 563.

Furthermore, the fuel cell stack 3 has a coolant inlet 35 and a coolant outlet 36. The coolant inlet 36 is connected with the liquid cooling device 37, which comprises a heat exchanger 371, a cooling fan 372, a fan controller 373, a temperature sensor 374, a water reservoir 375 and a pump 376. The temperature sensor 374 detects a temperature of the coolant flowing out from the coolant outlet 36. According to the coolant temperature detected, the fan controller 373 controls the operation of the cooling fan 372. Thereby, the coolant is properly cooled. Then, the coolant is pumped to the coolant inlet 35 of the fuel cell stack 3 by the pump 376.

The coolant is conveyed to the hydrogen supply module 4 to heat the hydrogen storage canisters 42 therein before it is conveyed to the heat exchanger 372. Physically, when hydrogen is released, it absorbs heat from the surrounding. The heat provided by the coolant promotes release of hydrogen from the hydrogen storage canisters 42. On the other hand, the hydrogen storage canisters 42 absorb heat from the coolant and reduce the coolant temperature.

Besides, the fuel cell power system comprises a volt monitoring module 38 which is connected with guide wires 381 of the cell units for measuring the voltages thereof. From the volt monitoring module 38, the user can observe the performance of the various cell units. To study the effects of various parameters to the performance of the fuel cell stack 3, the user may vary the operation parameters and observe the output voltages of the cell units individually.

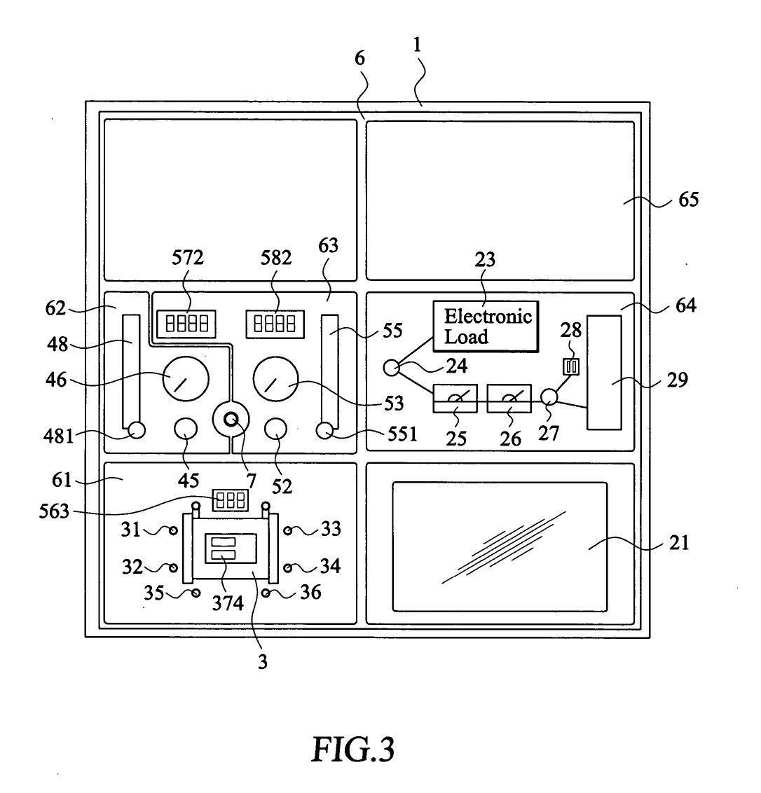

Please refer to FIG. 3 which shows a connection and display panel of the functional test and demonstration apparatus in accordance to a preferred embodiment of the present invention. The connection and display panel 6 is mainly divided into five regions, namely a fuel cell stack and gas supply connection region 61, an anode gas supply region 62, a cathode gas supply region 63, a load display region 64 and an auxiliary display region 65.

The connection and display panel 6 is provided with a plurality of joints for connection of the various components of the fuel cell power system. To clearly specify the functions of the joints, each of the joints is labeled with the same reference number as the connecting component.

The fuel cell stack and gas supply connection region 61 comprises a joint 31 for connecting to the hydrogen gas inlet 31, a joint 32 for connecting to the hydrogen gas outlet 32, a joint 33 for connecting to the air inlet 33, a joint 34 for connecting to the air outlet 34, a joint 35 for connecting to the coolant inlet 35 and a joint 36 for connecting to the coolant outlet 36.

A temperature indicator 374 is arranged on the fuel cell stack and gas supply connection region 61 for indicating the operating temperature of the fuel cell stack 3. Also, a temperature indicator 563 is arranged for indicating the temperature of the humidifier 56.

The pressure regulating valve 45, the pressure gauge 46, the rotameter 48 and the hydrogen flow control knob 481 are arranged on the anode gas supply region 62. Similarly, the pressure regulating valve 52, the pressure gauge 53, the gas flow rotameter 55, the air flow control knob 551, and the temperature meters 572, 582 are arranged on the cathode gas supply region 63. In addition, an emergency button 7 is arranged at an appropriate position between the anode gas supply region 62 and the cathode gas supply region 63, for terminating the hydrogen supply to the fuel cell stack 3 and power output from the fuel cell stack 3 in case of emergency.

The load display region 64 is provided with a load switch 24, a voltmeter 25, an ammeter 26, an AC power switch 27, an AC power socket 28 and a lamp 29. The functional test and demonstration apparatus can operate in two modes; one is for functional test and the other is for demonstration. The load switch 24 is used to turn the functional test and demonstration apparatus to perform functional test or demonstration. And, the functional test and demonstration apparatus is provided with a DC/AC converter to convert the DC power generated by the fuel cell stack 3 to AC power. By turning on the AC power switch 27, AC power is supplied to the AC power socket 28 or the lamp 29.

The auxiliary display region 65 enables the display of additional systems or parts. For example, the piping system and the control circuit of the fuel cell power system may be displayed on the auxiliary display region 65. Of course, the auxiliary display region 65 may also comprise other functions according to the training or demonstration objectives.

The control device 2 may comprise a PC computer or a control circuit. The control device 2 includes a receiving interface and an output interface. The receiving interface receives the signals from the various components of the functional test and demonstration apparatus, and the output interface controls the operation of the components. Please refer to FIG. 2. The signals from the temperature sensors 374, 563, 571, 581, the volt monitoring module 38, the pressure gauge 46 and the mass flow controllers 47, 48 are sent via the receiving interface to the control device 2. Subsequently, via the output interface, the control device 2 drives the components, such as the solenoid valve 322, mass flow controllers 47, 48 to operate.

From the preferred embodiment, it is noted that the present invention comprises a systemized arrangement of components and parts for comprehensive understanding of the operation principle or functional testing of the fuel cell power system. All components can be easily connected and assembled. Various detecting or regulating devices are directly arranged on the connection and display panel, making it very easy for reading of parameters or regulation. By means of the present invention, the functional tests or demonstrations of fuel cell power system can be easily and simply performed. In short, the functional and demonstration apparatus of the present invention highly facilitates and assists the illustration of operation principle and performance of functional tests at training of workers, exhibition, and product promotion.

Although the present invention has been described with reference to the preferred embodiments thereof, it is apparent to those skilled in the art that a variety of modifications and changes may be made without departing from the scope of the present invention which is intended to be defined by the appended claims.

1. A functional test and demonstration apparatus for a fuel cell power system, comprising:
a fuel cell stack having a hydrogen gas inlet, a hydrogen gas outlet, an air inlet, an air outlet, a coolant inlet and a coolant outlet;
a mainframe, which has a plane surface and supports the fuel cell stack;
a hydrogen supply module, which supplies hydrogen to the hydrogen inlet through a hydrogen supply pipeline, and excessive hydrogen is conveyed out from the hydrogen outlet of the fuel cell stack;
a blowing device, which draws in air and supplies air to the air inlet through an air supply pipeline, and excessive air is conveyed out from the air outlet of the fuel cell stack;
a liquid cooling device, which is connected between the coolant inlet and the coolant outlet for cooling the fuel cell stack;
a humidifier, which is provided at the air supply pipeline, for humidifying the inlet air;
a control device, which receives signals from the functional test and demonstration apparatus and controls the operation of the functional test and demonstration apparatus; and
a connection and display panel, which comprises a plurality of joints for connecting the hydrogen supply pipeline, the air supply pipeline, the fuel cell stack, the control device and the load system, and a plurality of indicating units for indicating an operation of the fuel cell stack.

2. The functional test and demonstration apparatus as claimed in claim 1, wherein on the plane surface of the mainframe, there is provided with a stand with an inclined top surface for supporting the fuel cell stack, such that the hydrogen gas outlet and an air outlet of the fuel cell stack are positioned at a vertically lower position of the stand.

3. The functional test and demonstration apparatus as claimed in claim 1, wherein the hydrogen supply module is arranged at one side of the mainframe and connected to the hydrogen inlet of the fuel cell stack by means of hoses, and the hydrogen supply module comprises at least one chamber where a low pressure hydrogen storage canister is accommodated;

4. The functional test and demonstration apparatus as claimed in claim 1, wherein the hydrogen supply pipeline comprises:
a pressure regulating valve for regulating and reducing the hydrogen pressure;
a pressure gauge for measuring and indicating the hydrogen pressure;
a mass flow controller for measuring the mass flow rate of hydrogen; and
a gas flow rotameter for controlling the hydrogen flow, which is provided with a hydrogen flow control knob in the front.

5. The functional test and demonstration apparatus as claimed in claim 4, wherein the hydrogen supply pipeline further comprises an emergency button for terminating the hydrogen supply to the fuel cell stack and power supply from the fuel cell stack at emergency

6. The functional test and demonstration apparatus as claimed in claim 1, wherein the hydrogen supply pipeline is connected with a nitrogen supply pipeline and the hydrogen gas inlet of the fuel cell stack by a three-way valve, in which nitrogen is supplied from a nitrogen supply through the nitrogen supply pipeline.

7. The functional test and demonstration apparatus as claimed in claim 1, wherein the hydrogen gas outlet is connected with a check valve and a solenoid valve, in which the check valve only allows hydrogen gas to flow from the hydrogen gas outlet to a gas exhaust and the solenoid valve is driven to open or close, for draining the water generated and accumulated in the fuel cell stack.

8. The functional test and demonstration apparatus as claimed in claim 1, wherein the air supply pipeline comprises:
a pressure regulating valve for regulating the air pressure;
a mass flow controller for metering and controlling air mass flow rate; and
a pressure gauge for measuring the air pressure, which is provided with an air flow control knob in the front.

9. The functional test and demonstration apparatus as claimed in claim 1, wherein both the conduit connecting the humidifier and the air inlet of the fuel cell stack and the conduit connecting between the air outlet of the fuel cell stack and the humidifier are heat-insulated by thermal sleeves.

10. The functional test and demonstration apparatus as claimed in claim 1, wherein the air inlet and air outlet of the fuel cell stack are equipped with temperature sensors for measuring the temperatures therein, and thereby the efficiency of the humidifier is derived.

11. The functional test and demonstration apparatus as claimed in claim 1, wherein the humidifier is equipped with a heater and a temperature controller for controlling the temperature of the humidifier, and by this way, humidification to the inlet air is regulated.

12. The functional test and demonstration apparatus as claimed in claim 1, wherein the functional test and demonstration apparatus further comprises a volt monitoring module which is connected with guide wires of the cell units of the fuel cell stack for measuring the voltages thereof, for studying the effects of various parameters to the performance of the fuel cell stack.

13. The functional test and demonstration apparatus as claimed in claim 1, wherein the liquid cooling device comprises a heat exchanger, a cooling fan, a fan controller, a temperature sensor, a water reservoir and a pump, in which the temperature sensor detects a temperature of the coolant flowing out from the coolant outlet, and the fan controller controls the operation of the cooling fan according to the coolant temperature.
